(19) United States
(12) Patent Application Publication
(10) Pub. No.: US 2005/0179946 A1
(43) Pub. Date: Aug. 18, 2005

(54) Image outputting system, image processing apparatus, image processing method and program thereof

(75) Inventors: Masahiro Takamatsu, Kanagawa (JP); Satoshi Usui, Kanagawa (JP); Hitoshi Ogatsu, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 10/975,412

(22) Filed: Oct. 29, 2004

(30) Foreign Application Priority Data
Sep. 19, 2003 (JP) P. 2003-328544

(51) Int. Cl. G06F 15/00

(52) U.S. Cl. 358/1.18

(57) ABSTRACT

An image processing apparatus which executes processing for printing an image on both surfaces of a sheet includes an image input part for inputting photographic image information to be printed, a show-through effect degree judging part for judging the show-through effect degree of the image formed on the both surfaces of the same sheet from the photographic image information inputted, a layout processing part for subjecting the surface and rear of the sheet from the judgment due to the show-through effect degree judging part to layout processing, and an image outputting part for outputting the image information subjected to layout processing by the layout processing part.

### BACKGROUND OF THE INVENTION

1. Field of the Invention

The present invention relates to an image outputting system or the like for outputting an image to a sheet, and more preferably relates to an image outputting system or the like for outputting the image to both surfaces of the sheet.

2. Description of the Related Art

In recent years, a high level of image quality in a digital camera and camera functions of a mobile phone or the like have advanced, and various applications using a digital photographic image have been widely expanded. For example, the high level of image quality of a printer or the like employing an electrophotographic method and an inkjet method has quickly advanced, and a photographic image showing almost the same high image quality as a silver lead photograph can be simply and quickly outputted. As techniques advance, there has been proposed a technique for putting together all the photographic image data conventionally received via a network onto one print sheet (for example, see JP-2002-132923 (page 2 to 3, FIG. 1)).

As other prior art, there has been proposed a print preparation in which a plurality of images are assigned to an electronic album of every 2-spread pages and a binding margin is provided at one end (for example, see JP-2002-178588 (page 11, FIG. 23)). In addition, a technique exists, in which photographic images comprising a plurality of frames are printed on an output sheet of size A4, and the attribute information corresponding to the frames of the surface is recorded on the rear surface of the output paper (for example, see JP-10-213856 (page 9, FIG. 1)).

### SUMMARY OF THE INVENTION

Thus, for example, it is said that the high level of image quality of a printer or the like employing electrophotographic shifts to a culture for outputting a plurality of images to one sheet from a culture for outputting the digital photographic images photographed by, for example, the conventional digital camera to one sheet. By forming a plurality of images on one sheet, for example, an album and an index print or the like are easily prepared, and for use and preservation of the image, many preferable forms can be proposed. If the image could be formed on both surfaces of the sheet, the housing capacity of a file can be greatly improved. When the sheets are filed, for example, as an album, the photographic images can be seen as a spread, and the utility value becomes still higher.

However, there is a fear that the image of the rear surface (second surface) is transmitted to the surface (first surface), and has a negative influence on the image of the surface when a technique for printing the image on both surfaces of the sheet is employed, and for example, the image is formed on both surfaces of a thin paper. Though a character prior image output exerts comparatively few adverse effects due to the show-through effect in conventional business society, it is not preferable that the image of the surface is confused by a show-through effect when image information such as photographic images are printed. Even if the influence of this show-through effect appears notably in a sheet having a typical thickness, an image having a high density and an image having a strong edge degree are printed on the rear surface.

The various patent documents do not handle the influence of the show-through effect. In particular, in JP-10-213856, when characters are printed on the rear surface of the photographic images, the edge degree of the character is very high. When the characters are printed on a typical sheet, the characters of the rear surface are photographed to the photograph of the surface.

An image outputting system to which the present invention is applied acquires image information to be printed to a sheet by using an image information acquiring unit, and acquires the rear surface information of the sheet on which the image information acquired is printed by using a rear surface information acquiring unit. The layout of the image information acquired by the image information acquiring unit to the sheet is determined by using a layout determining unit based on the rear surface information of the sheet acquired by the rear surface information acquiring unit, and the image information is printed by a printing unit in the layout determined by the layout determining unit.

From another point of view, an image outputting system to which the present invention is applied acquires a plurality of photographic images photographed by using a photographic image acquiring unit, rearranges a plurality of photographic images acquired in consideration of the overlap condition on both surfaces of a sheet, and sets the layout of both surfaces of the sheet by using a layout setting unit. A plurality of photographic images are printed on both surfaces of a sheet according to the layout set by the layout setting unit and by a printing unit.

On the other hand, an image processing apparatus of the present invention executes processing for printing an image on both surfaces of a sheet. The image processing apparatus acquires the image information to be printed by using an image information acquiring unit, and recognizes the rear surface information of the image formed on the rear surface of the sheet by using a recognizing unit from the image information acquired by the image information acquiring unit. The surface image formation condition determining unit determines the image formation condition of the image formed on the surface of the sheet based on the rear surface information recognized by the recognizing unit.

From another point of view, an image processing apparatus of the present invention executes processing for printing an image on both surfaces of a sheet. The image processing apparatus acquires the image information to be printed by using an image information acquiring unit, and judges the show-through effect degree of the image formed on the both surfaces of the same sheet by using a show-through effect degree judging unit from the image information acquired. From the judgment due to the show-through effect degree judging unit, at least one of the surface and rear surface on the sheet is subjected to layout processing by a layout processing unit, and the image information subjected to layout processing by the layout processing unit is outputted by an output unit.

An image processing method for printing an image on the first surface and second surface of a sheet according to the present invention, comprising the steps of acquiring the image information to be printed, developing the image formed on the first surface and second surface of the sheet for the image information acquired on a memory, judging the overlap situation of the first surface and second surface on the sheet based on the image developed on the memory, and determining the image formation condition of the first surface and/or second surface from the overlap situation judged.

On the other hand, according to the present invention, a computer device constituting a system via a network and a computer device used for a store of a photograph print service and a convenience store or the like can be operated as a program which realizes a predetermined function. That is, a program to which the present invention is applied inputs the photographic image information to be printed on both surfaces of a sheet into a computer, realizes a function for developing information on a memory, a function for judging the overlap situation of the photographic image information on both surfaces of the sheet from the photographic image information developed and a function for setting the layout of the photographic image information on both surfaces of the sheet from the overlap situation judged.

When these programs are provided to the computer, for example, a form for providing as a storage medium storing the program such that the program for making the computer execute can be read by the computer can be considered besides the case that the program is provided in the state where the program is previously installed in a computer device. As this storage medium, for example, a DVD and a CD-ROM medium or the like are applicable, and programs are read by a DVD and a CD-ROM reader or the like. The programs are stored in a HDD or a flash ROM or the like, and the programs are executed by the CPU. For example, these programs may be provided via the network from a program transmission device.

### BRIEF DESCRIPTION OF THE DRAWINGS

Preferred embodiment of the present invention will be described in detail based on the following figures, wherein:

FIG. 1 shows an overall configuration of an image outputting system to which the embodiment is applied;

FIG. 2 shows an example of a printer in an image output side;

FIG. 3 is a block diagram showing the functional configuration of an image processing apparatus;

FIG. 4 is a flow chart showing a processing executed by an image processing apparatus;

FIG. 5 is a flow chart showing a flow of judgement of show-through effect degree/reduction processing;

FIG. 6 shows an example for judging show-through effect degree for every region;

FIG. 7A to 7D show an example of a layout processing due to a layout processing part; and

FIG. 8A to 8D show another example of a layout processing due to a layout processing part.

### DETAILED DESCRIPTION OF THE INVENTION

Hereinafter, with reference to accompanying drawings, the embodiment of the invention will be explained in detail.

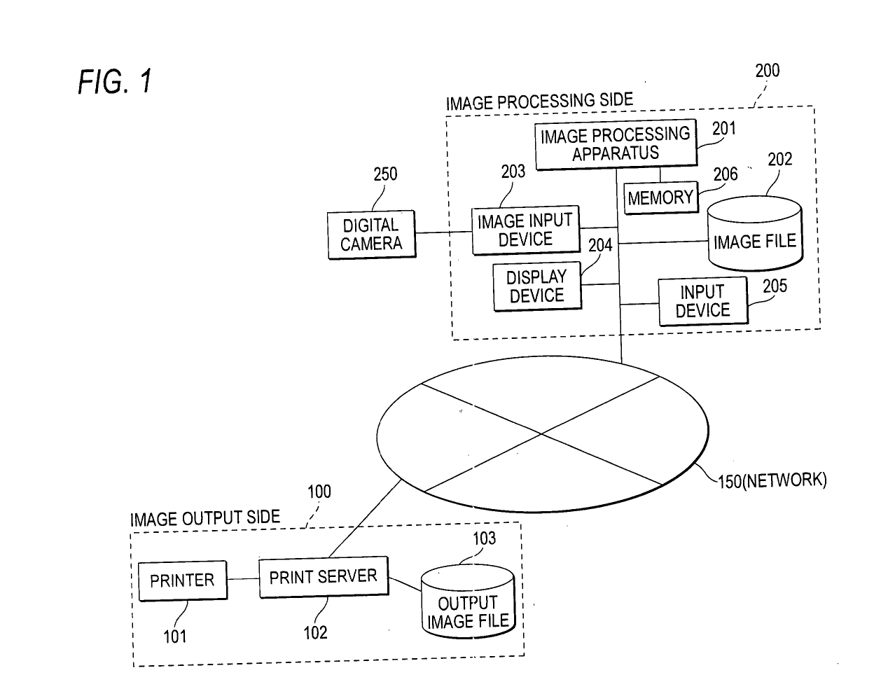

FIG. 1 shows an overall configuration of an image outputting system to which the embodiment is applied. Herein, an image output side 100 for outputting an image on a sheet (a paper, a record paper and an output medium) and an image processing side 200 composed by a computer device or the like such as a personal computer (PC) composed so as to be connected with, for example, a digital camera 250 are provided, and these are connected via the network 150. The network 150 may be a public and broad network such as the Internet and a local network. The system of the embodiment can also be constructed in a closed form like an intranet within a company such as Ethernet (Xerox Corp.™). At the shop front of a print service company, the form in which the printer 101 of the image output side 100 is directly connected with the image processing side 200 through an interface such as a USB (Universal Serial Bus) is also considered.

The image output side 100 is provided with a printer 101 comprising an image forming device such as a laser printer capable of performing the double-sided image formation for forming an image on both surfaces of a paper, a print server 102 which is connected with the network 150, receives the print request from image processing side 200 and performs image output control to the printer 101, and an output image file 103 which stores the output image receiving the print request. The print server 102 can be configured by the computer device such as the PC, and the output image file 103 can configured by a hard disk drive (HDD) built in the PC or the like which functions as for example, the print server 102, an external HDD and various optical discs or the like.

The image processing side 200 is provided with an image processing apparatus 201 which performs various processing operations such as layout processing and image conversion to the image printed out by the image output side 100, an image file 202 which stores the image inputted and the other various images, and an image input device 203 which inputs various image information (image) such as photographic images from a digital camera 250 connected with the PC or the like of the image processing side 200 and various removable memories (not shown) or the like. In addition, the image processing side 200 is provided with a display device 204 which receives various inputs which comprise various displays such as an LCD (Liquid Crystal Display), for example, and displays the various images, and an input device 205 which receives various inputs such as layout selection from a user. Further, the image processing side 200 is provided with a memory 206 which is a memory for work at the time of work due to the image processing apparatus 201 and stores the various table information or the like used for image processing. For example, application programs are executed by the CPU in the PC in the image processing apparatus 201 by hardware, and a memory 206 can be used as a storage device for work at the time of execution.

The print server 102 can be omitted in the image output side 100, and the printer 101 can be directly connected with the network 150. The image output side 100 can also be connected with the image processing side 200 directly via a cable or the like. All functions such as the image edit function of the image processing apparatus 201 in the image processing side 200 may be provided in the printer 101. In this case, an application program which develops the image processing apparatus 201 is executed by the CPU used for the printer 101.

Herein, first, the image formation function will be explained.

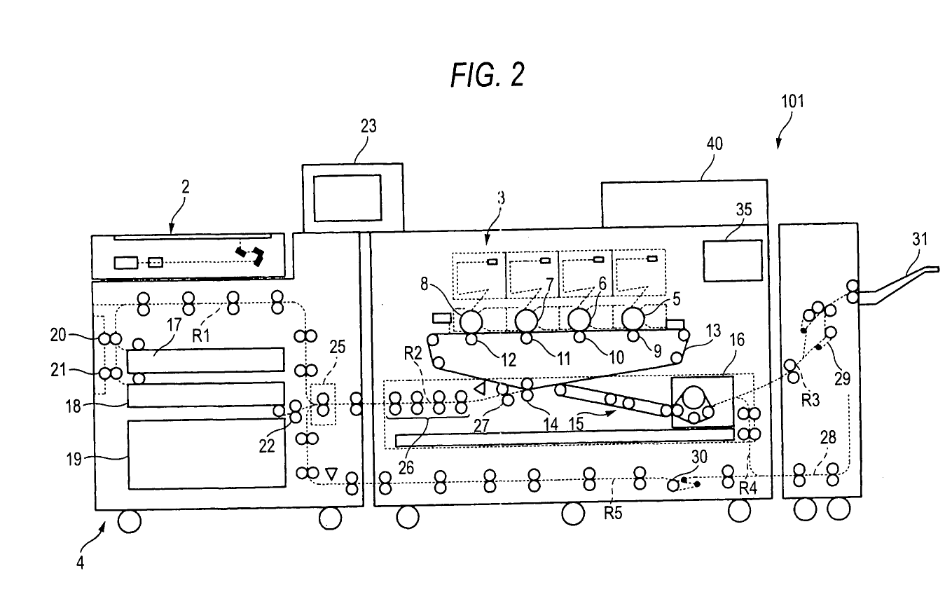

FIG. 2 shows an example of the printer 101 in the image output side 100. Herein, a full color laser printer system which can perform automatic double-sided printing is mentioned as the example. The printer 101 is composed by an image formation part 3 which forms an image on a paper (sheet) and a sheet feed part 4 which supplies the sheet to the image formation part 3. Also, the printer 101 is provided with an image read part 2 which reads the image of a manuscript as a composite machine and has a function as a copying machine. Further, the printer 101 is provided with a control part 35 which controls the entire printer 101. Further, the printer 101 is provided with an IPS 25 (Image Processing System) 40 which executes improvement processing or the like in quality of image to the output image data inputted.

The image formation part 3 is provided with four photo conductor drums 5, 6, 7, 8 which correspond to each color of yellow (Y), magenta (M), cyan (C) and black (K), and are arranged in parallel in the horizontal direction, four primary transfer rolls 9, 10, 11, 12 arranged so as to correspond to the photo conductor drums 5 to 8 respectively, an intermediate transfer belt 13 on which the toner image formed on the photo conductor drums 5 to 8 is primarily transferred sequentially, a secondary transfer roll 14 which transfers the toner image superimposed on the intermediate transfer belt 13 secondarily on the sheet in a secondary transfer part; a vacuum carrying part 15 which carries the sheet after secondary transfer, and a fixing unit 16 which fixes the toner image to the sheet after transfer. The image formation part 3 has the configuration of so a called four-series tandem type.

Herein, a charger which uniformly charges the surface of each of the photo conductor drums 5 to 8 around each of the photo conductor drums 5 to 8, a laser write device which forms an electrostatic latent image on the surfaces of the electrified photo conductor drums 5 to 8 electrified by the charger by using laser irradiation, a developing unit which develops and visualizes the electrostatic latent image formed on the photo conductor drums 5 to 8 by using a predetermined color ingredient toner, and a cleaner which removes the remaining toner on the surfaces of the photo conductor drums 5 to 8 after primary transfer are arranged or the like. On the other hand, the primary transfer rolls 9 to 12 are oppositely arranged through the intermediate transfer belt 13 near the photo conductor drums 5 to 8 corresponding to the primary transfer rolls 9 to 12 respectively. The primary transfer rolls 9 to 12 transfer primarily the toner image formed on the photo conductor drums 5 to 8 corresponding to primary transfer rolls 9 to 12 to the intermediate transfer belt 13.

The secondary transfer roll 14 is arranged so as to oppose the intermediate transfer belt 13. The secondary transfer roll 14 transfers secondarily (batch transfer) the superposed toner image of each color primarily transferred sequentially on the intermediate transfer belt 13 on the sheet. The vacuum carrying part 15 carries the sheet on which the toner image is transferred by the secondary transfer roll 14 to the fixing unit 16, while attracting the sheet, and the toner image is fixed to the sheet by heating and pressurizing or the like in the fixing unit 16.

On the other hand, the sheet feed part 4 carries the sheets stored in a first tray 17, a second tray 18 and a third tray 19 respectively by using a predetermined carrying path. Near the trays 17 to 19, feed-out rolls 20, 21, 22 corresponding to the trays 17 to 19 respectively are arranged. Each of the feed-out rolls 20 to 22 forms a nip on the sheet separately taken out one by one from the trays 17 to 19 corresponding to the feed-out rolls 20 to 22, and makes the sheet suspend on the sheet carrying path, and feeds out the sheet in the downstream of the sheet carrying direction at the timing based on a predetermined start signal. An operation panel 23 in which operation information can be inputted by a user is arranged near the image read part 2.

From the feed-out position of the sheet due to each of the feed-out rolls 20 to 22, carrying rolls for carrying the sheet are suitably arranged on a series of sheet carrying paths R1 to R5 which lead to a discharge tray 31 through the image formation processing position of the image formation part 3 respectively. After the sheets stored in the first tray 17 are fed out by the feed-out roll 20, the sheets are fed to a merging carrying part 25 through the first sheet carrying path R1. After the sheets stored in the second tray 18 are fed out by the feed-out roll 21, the sheets are fed to the merging carrying part 25 through the first sheet carrying path R1. On the other hand, the sheets stored in the third tray 19 are directly fed to the merging carrying part 25 by the feed-out roll 22.

The sheet fed to the merging carrying part 25 is fed to the image formation processing position of the image formation part 3 through the second sheet carrying path R2. After the sheet passing through the image formation processing position is fed to the fixing unit 16 by the vacuum carrying part 15, the sheet is discharged to the discharge tray 31 through the third sheet carrying path R3. On the other hand, a sheet having both surfaces on which the image is formed is fed to the double side reversing part 28 through the fourth sheet carrying path R4 after passing the fixing unit 16. After the sheet is inverted inside and outside in the double side reversing part 28, the sheet is again fed to the merging carrying part 25 through the fifth sheet carrying path R5.

A posture correcting part 26 which corrects the posture of the sheet carried on the second sheet carrying path R2 and a resist roll 27 are arranged on the second sheet carrying path R2 of the sheet carrying paths R1 to R5. The resist roll 27 is composed by a pair of rolls held in a state where they come into press-contact with each other, and feeds the sheet to the image formation processing position by rotating the roll pairs while nipping on the sheet between the pair of rolls. Curl correcting parts 29, 30 which correct the curl of the sheet generated when fixing in the fixing unit 16 are respectively arranged on the sheet carrying paths R3, R5.

The output image data acquired from a print server 102 is inputted in an IPS40 in response to the output request from the image processing side 200 shown in FIG. 1. For example, the IPS40 writes the electrostatic latent image of the first surface on the surfaces of the photo conductor drums 5 to 8 at a specified timing while controlling the printer 101 by using a control part 35 based on the output image data. The toner image primarily transferred to the intermediate transfer belt 13 by the electrostatic latent image written on the photo conductor drums 5 to 8 is secondarily transferred, for example, on the surface (first surface) of the sheet carried, and the toner image is fixed by the fixing unit 16. Thus, for example, a sheet having a first surface on which the output image is formed, is moved to a transfer position again through the fifth sheet carrying path R5. On the other hand, next, the IPS40 writes the electrostatic latent image of the second surface of output image data on the surfaces of the photo conductor drums 5 to 8, and similarly, the toner image is secondarily transferred to the rear surface k (second surface) of the sheet. Then, the toner image is fixed by the fixing unit 16 and the sheet is discharged to the discharge tray 31. The output image is formed on both surfaces of the sheet by the series of image forming operations.

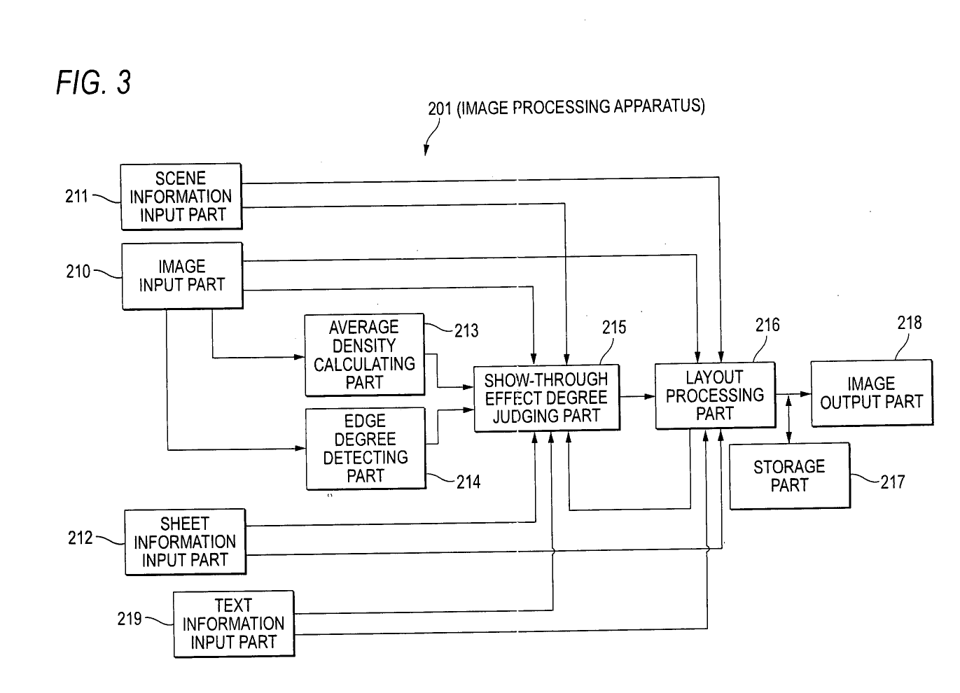

Next, the processing executed in the image processing side 200 will be explained. FIG. 3 is a block diagram showing the functional configuration of the image processing apparatus 201, and shows only a characteristic configuration part in the embodiment.

The image processing apparatus 201 to which the embodiment is applied, is provided with an image input part 210 which inputs image information (image information) inputted from the image input device 203, a scene information input part 211 which inputs scene information such as photography mode (for example, night view mode, person mode, scene mode) at the time of photographing by using a digital camera 250 or the like, a paper information input part 212 which inputs sheet (paper) information at the time of being outputted by the printer 101, and a text information input part 219 which inputs information such as text. This paper information input part 212 acquires information such as the thickness of the paper respectively stored in each of the paper trays (first tray 17, second tray 18 and third tray 19) from, for example, the paper information inputted by the user via the operation panel 23 of the printer 101. The information of the paper outputted is recognized based on the tray information etc., selected by the user from the input device 205 of the image processing side 200.

The image processing apparatus 201 is provided with an average density calculation part 213 which calculates the average density of the image inputted by the image input part 210, and an edge degree detection part 214 which detects the edge degree of the image inputted by the image input part 210. Further, the image processing apparatus 201 is provided with a show-through effect degree judging part 215 which judges the show-through effect degree of the second surface at the time of viewing the first surface from the average density of the first surface calculated by the average density calculation part 213 based on the average density calculated by the average density calculation part 213 to the image of the second surface (rear surface) when the image of the first surface (surface) is formed and the edge degree detected by the edge degree detection part 214 to the image of the first surface (surface). The judgment of the show-through effect degree judging part 215 is judged based on the paper information inputted by the paper information input part 212. For example, the show-through effect degree judging part 215 can judge the show-through effect degree by using the scene information acquired from the scene information input part 211 such as “dark” in the case of night view mode.

The image processing apparatus 201 is provided with a layout processing part 216 subjecting a paper (sheet) on which the image is outputted to layout processing based on the judging result or the like due to the show-through effect degree judging part 215, a storage part 217 which once stores the output image processed by the layout processing part 216, and an image outputting part 218 which outputs the output image processed by the layout processing part 216 via the display device 204 and the network 150 or directly to the image output side 100.

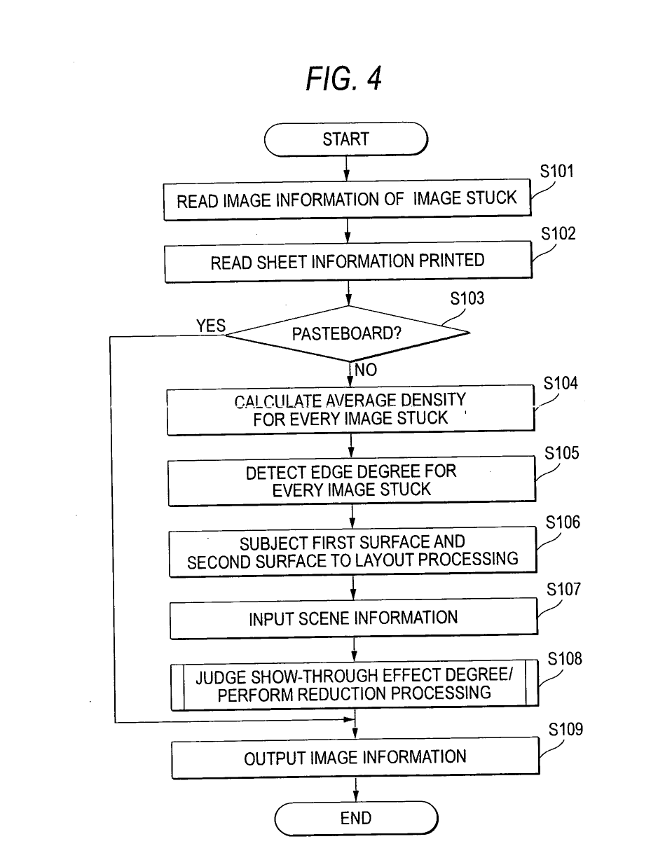

FIG. 4 is a flow chart showing a processing executed by the image processing apparatus 201. First, for example, the image information of the image stuck such as the photographic image is read by the image input part 210 (S01). The paper information printed is read by the paper information input part 212 (S102). It is judged whether or not the paper (sheet) printed is a pasteboard by reading the paper information (S103). When the paper is the pasteboard, it is judged that almost no danger of show-through effect exists, and it is made to move to the output of the image information of S109 as it is. Since the influence of the show-through effect may be generated when the paper is not the pasteboard, the following processings are executed.

First, the average density is calculated for every image such as the photographic image stuck in the average density calculation part 213 (S104). In the average density calculation, for example the input image information inputted by the color signal of a RGB color system can be changed into CIEL*a*b*, and the average density can be acquired by equalizing the value of L*. In the case of a monochrome image, the average of the density can be calculated by using the gradation data (0 to 255) of, for example, 8 bits. Next, the edge degree is detected for every image such as the photographic image stuck in the edge degree detection part 214 (S105). In the detection of the edge degree, for example, the input image information inputted by the color signal of RGB can be changed into L*a*b*, for example, the variation of the value of L* can be measured between the peripheral pixels around a notice pixel, and the edge degree can be detected. In the case of monochrome image, the edge degree can be detected depending on whether the change of the gradation data is large or not. When the background is “sky” whose L* is high and on which a human image exists, and “black hair” whose L* is low comes into contact with “sky” as an example of the photographic image, the edge degree of the place becomes high.

Next, before or after processing of the calculation and detection, the first surface and the second surface is subjected to layout processing in the layout processing part 216 (S106). The layout processing is set according to the output form requested and the output purpose or the like such that the share of all the images stuck on both surfaces is set to less than 50%, for example to the paper size inputted by the paper information input part 212. At the time of subjecting to layout processing, the layout is changed to a legible layout, and the order of the layout is determined based on a request from the user, the order of time information photographed and the scene information inputted by the scene information input part 211, and an arbitrary processing can be added. The layout processing performed herein is the preliminary layout processing executed in the next processing for reducing the show-through effect. On the other hand, scene information is inputted by the scene information input part 211 for every photograph pixel stuck. In the case of image information other than image information photographed, this processing is not performed. In the case of character information or the like, the processing is not performed in the same manner. Next, based on the information, the show-through effect degree is judged and reduction processing is performed by the show-through effect degree judging part 215 and the layout processing part 216 (S108). Then, the image information is outputted from the image outputting part 218 through the network 150 (S109), and the processing is completed.

Next, the show-through effect degree judgement/reduction processing of S108 will be explained.

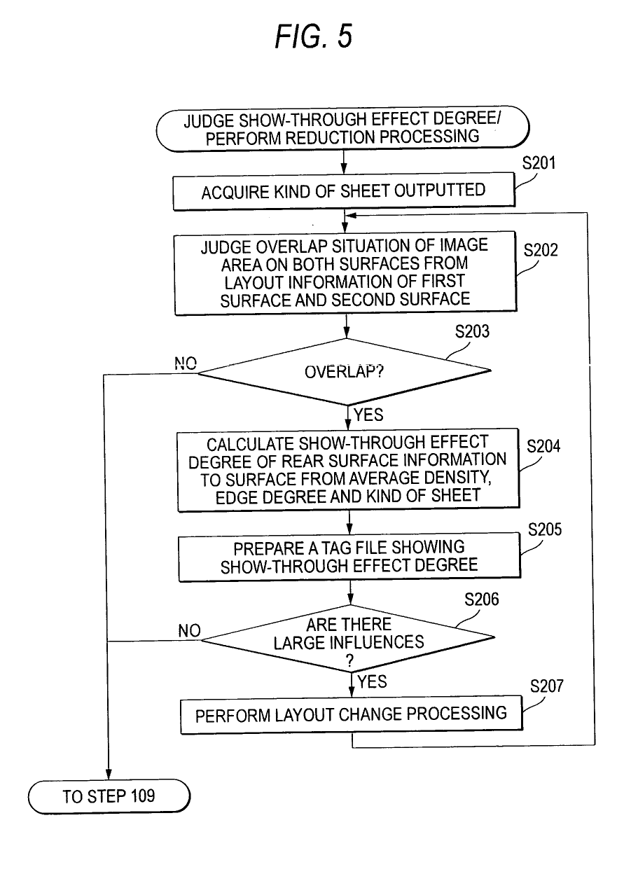

FIG. 5 is a flowchart showing the flow of the show-through effect degree judgement/reduction processing. In the show-through effect degree judging part 215, first, information concerning the kind of paper (sheet) outputted is acquired (S201). As the information concerning the kind of the paper acquired, for example, the information of a tracing paper, a thin paper, a typical copy paper, a coated paper for a photograph or the like is used. Next, in the show-through effect degree judging part 215, the overlap situation of the image area is judged on both surfaces from the layout information of the first surface and second surface (S202). As the premise of the judgment, for example, in order to judge the overlap situation of the rear surface on the first surface, the reversal processing of the left and the right sides is performed on the memory on which the image information of the second surface as the rear surface is developed. The overlap situation at the time of using the first surface as the surface can be judged by overlapping the image information of the second surface whose right and left are inverted on the memory with the image information of the first surface. When viewing only the overlap situation, only the processing at the time of using the first surface as the surface is performed. Herein, it is judged whether the image area is overlapped on both surfaces (S203). When the image area is not overlapped, it is made to move to S109, without performing the show-through effect degree reduction processing.

When the image area is overlapped, the show-through effect degree of the rear surface information to the surface is calculated from the average density calculated by the average density calculation part 213, the edge degree detected by the edge degree detection part 214 and the paper kind recognized (S204).

For example, the show-through effect degree can be composed so as to judge in the rectangle area range of a predetermined size such as 64×64 dots or in 128×128 dots. As the show-through effect degree, the level of the image density of the rear surface existing at the position reflected is first judged based on the image density of the surface in the area and the image density of the rear surface whose the right and left are inverted on the memory. The level is judged by using the edge degree acquired.

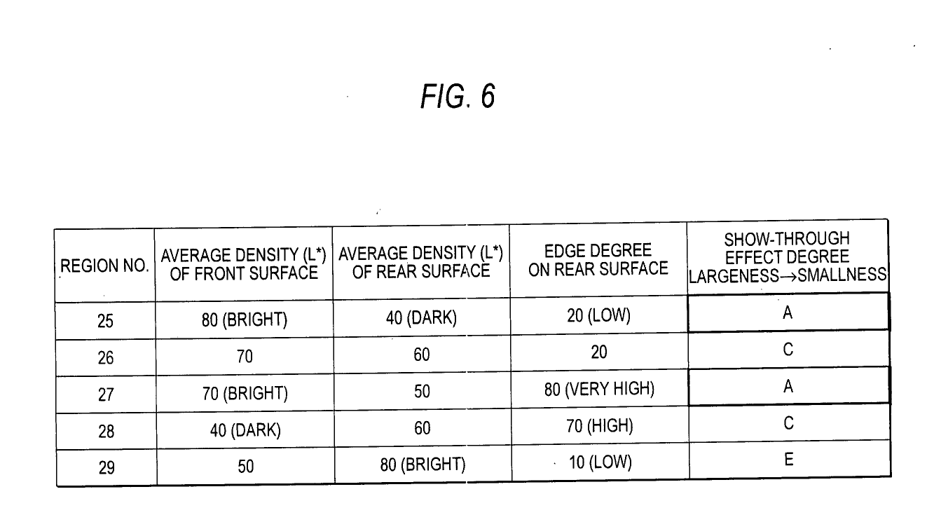

FIG. 6 shows the example of the show-through effect degree judgement for every region. Herein, for example, the judging result of the show-through effect degree is shown for five region numbers 25 to 29 based on the average density (L*) of the surface, the average density (L*) of the rear surface and the edge degree of the rear surface. Herein, the evaluation is performed as the show-through effect degree in five steps of from A (largeness) to E (smallness). Though the edge degree of the rear surface is low in the region number 25, the average density of the surface is low (bright), and the average density of the rear surface is high (dark). As a result, the image of the rear surface is reflected as the whole region, and the show-through effect degree becomes high. Though the density difference of both surfaces is small in the region number 27, the edge degree on the rear surface is very high. As a result, the show-through effect degree becomes high.

The example of the case where the paper is one kind is shown in FIG. 6, and the evaluation result of the show-through effect degree differs depending on the kind of paper. If the information according to the kinds of paper is stored in a predetermined memory as table information, the suitable show-through effect degree can be judged according to the kind of paper selected. When for example, text information such as character exists, the show-through effect degree can also be increased as one having the high edge degree.

Returning to the processing of FIG. 5, the show-through effect judging part 215 prepares the tag file showing the show-through effect degree on a predetermined memory for the show-through effect degree judged as described above (S205). For example, the level of the show-through effect degree for the image output page prepared can be grasped by storing the tag information showing the “A (high)” judgement while corresponding to a region. It is judged whether one having a large influence of the show-through effect degree (S206) exists from the preparing result of the tag file or not. When the one having large influence of the show-through effect degree (S206) does not exist, it is made to move to S109 shown in FIG. 4 as it is. When the one having a high influence degree exists, the layout change processing due to the layout processing part 216 is executed (S207). Then, returning to S202, the judgment of the show-through effect degree due to the show-through effect degree judging part 215 is repeated. When the overlap is lost, or the influence of the show-through effect degree becomes small, it is made to move to S109 shown in FIG. 4, and the show-through effect degree judgement/reduction processing is completed.

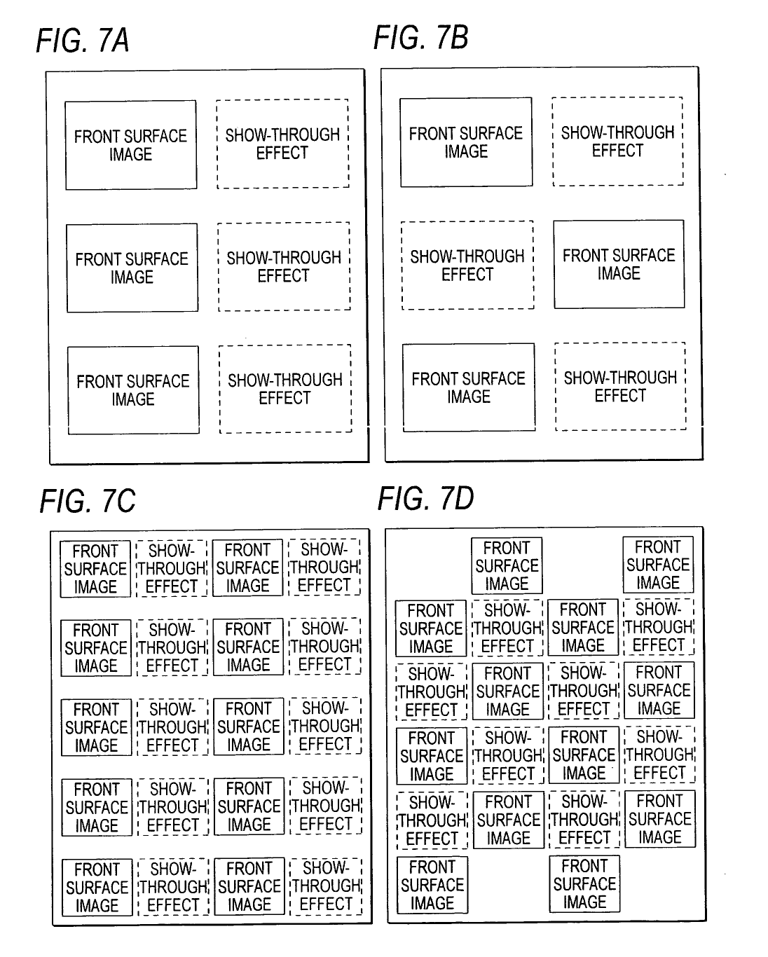

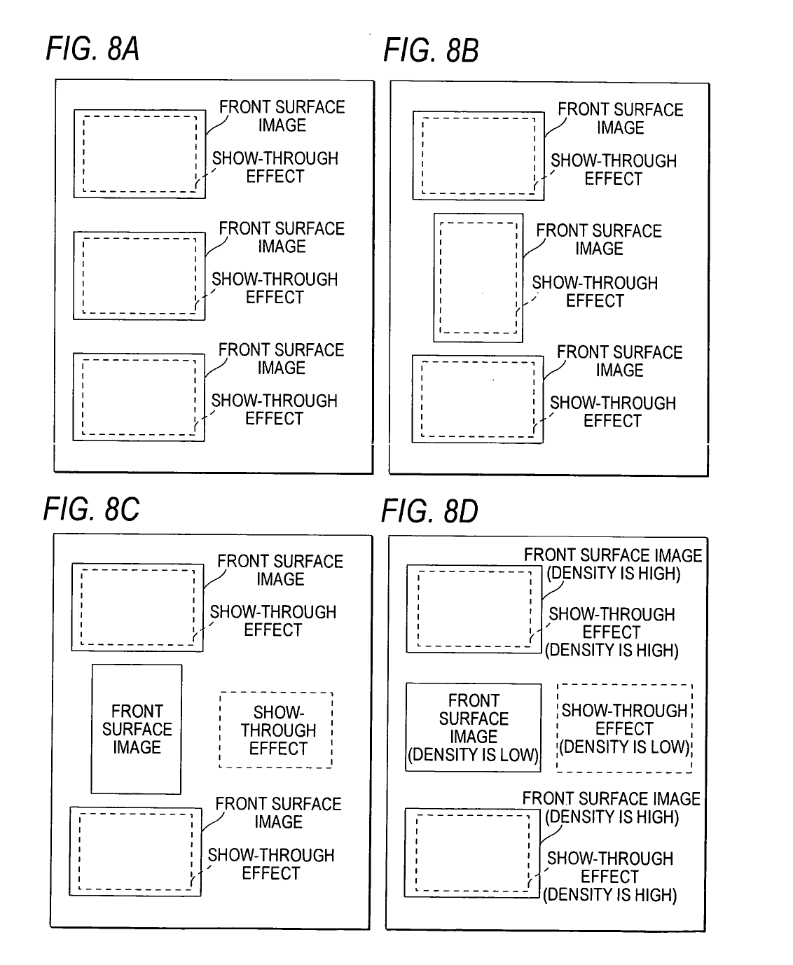

FIGS. 7A to 7D and FIGS. 8A to 8D show examples of layout processing due to the layout processing part 216. FIGS. 7A to 7C show the example of the image viewed from the first surface (surface), and the image portion formed on the second surface (rear surface) is shown with a broken line. FIGS. 7A to 7C are an example in which the layout processing is executed such that both surfaces are not overlapped. FIGS. 7A, 7B show the case where a total of six photograph images are stuck on both surfaces, and FIG. 7C, 7D show the case where a total of 20 photograph images are stuck on both surfaces. The example of the case where the number of sheets differs on both surfaces of the sheet is shown in FIG. 7D. Thus, in the layout change processing due to the layout processing part 216, the influence of the show-through effect can be greatly reduced by adjusting such that the position of the image print is not overlapped on the first surface and the second surface.

On the other hand, the example of the case where the image formation position (print position) of both surfaces are overlapped is shown in FIGS. 8A to 8C. In FIG. 8A, the layout processing is executed such that the region in which the print position of the first surface is overlapped with that of the second surface is the largest for all horizontally long photographic images. Though the show-through effect portion shown with the broken line is shown such that the show-through effect portion becomes slightly small in figures, this is for facility of the diagram illustration and is not necessarily small. However, so as to make the influence of the show-through effect small on both surfaces, it is also effective to change the image size.

In FIG. 8B, the case where the photographic images stuck are mixed lengthways and sideways is mentioned as an example. In this case, if both surfaces are overlapped while the length corresponds to the length, and the side corresponds to the side, it is possible to reduce the influence of the show-through effect, particularly the edge degree generated in the position of the frame of the photographic image.

Further, FIG. 8C shows the example executing the image processing such that the length is overlapped with the side when the length is the same as the side without overlapping in the case where the photographic images stuck are mixed lengthways and sideways, and the size of the length is different from that of the side. Thereby, the image of which the size differs for the show-through effect portion is not overlapped, and the influence of the edge Part of the image can be lost.

The example for judging whether the image is overlapped according to the density or not is shown in FIG. 8D. Since the surface image is easily influenced by the show-through effect of the image of the rear surface when the density of the surface image is low, it is preferable that the surface image is overlapped with the image of the rear surface when the density is low. On the other hand, since the surface image hardly receives the influence from the rear surface, even if the surface image is overlapped with the image of the rear surface, there are few negative influences to the image.

The aspect of overlap as shown in FIG. 8A to 8D is particularly effective when embedding text information in a blank, for example, or when enabling entry of a character due to the user in a blank. The text information or the note due to a pen of the user has a tight edge degree, and the influence of the show-through effect becomes quite large. It is preferable to adjust such that both surfaces are overlapped and the region is secured so as to cope with the problem previously. The effect that the show-through effect of an unfilled space part is not conspicuous can also be expected by making the image layouts of both surfaces completely overlap. When the text information having a large edge degree is printed, it is also effective to lower the density.

The size information of each picture information (image information) stuck besides the information of the edge degree and the density information of both surfaces described above can also determine whether the images of both surfaces as shown in FIGS. 7A to 7D and FIGS. 8A to 8D are overlapped or not. The decision can be performed by the size of the edge detected or the like.

As described above in detail, in the embodiment, for example, a plurality of images such as the album formation and the index print are formed on one page based on a plurality of image information by setting the layout of the surface based on the layout situation of the rear surface. Further, the deterioration of the print quality can be reduced for the show-through effect generated when the image is formed on both surfaces. Therefore, for example, if the image is adjusted such that the share of the image of both surfaces to the sheet surface is set to less than 50%, the layout can be set such that the surface image is not overlapped with the image of the rear surface on both surfaces. The edge of the image arranged on the rear surface when the surface image of both surfaces is overlapped with the image of the rear surface in a halfway manner is extremely emphasized, and the influence of the show-through effect becomes very large. Thereby, the layout can be set such that the region where the print positions of the images of the both surfaces are overlapped are the largest, or the layout can be set such that the region where the print positions of the both surfaces are not overlapped is the largest.

The embodiment can be further applied, and the density of the image information to be printed can be set such that the density of the image information to be printed by using not only the determination of the layout as a print position but also the rear surface can be changed. For example, when it is judged that the influence of the show-through effect is large, it is also effective to change the density of the image information acquired or reduce the density of the text information printed.

The rear surface information acquiring unit of the image outputting system to which the present invention is applied can be characterized by judging the show-through effect degree by calculation of the average density of the image formed on the rear surface of the sheet and/or detection of the edge degree. The layout determining unit can be characterized by that the layout is determined such that image information is not overlapped with the image of the rear surface of the sheet since the edge degree of the show-through effect becomes high when both surfaces are overlapped in a halfway manner, or a print position is determined such that the image information is not overlapped with the image of the rear surface of the sheet. The image outputting system to which the present invention is applied is further provided with the scene information inputting unit which inputs the scene information during photographing in the photographic images acquired by the photographic image acquiring unit. If the layout setting unit can be characterized by setting the layout of both surfaces of the sheet based on the scene information inputted by the scene information inputting unit, it is preferable that the layout setting unit can set the layout according to the feature of the scene.

A surface image formation condition determining unit of the image processing apparatus to which the present invention is applied is characterized by determining the layout of the image formed on the surface of the sheet, and particularly is characterized by determining the layout of the image formed on the surface of the sheet based on the position of the image formed on the rear surface of the sheet.

The image information acquired by the image information acquiring unit includes photographic image information, and the surface image formation condition determining unit can be characterized by determining the layout of the photographic image information.

The show-through effect degree judging unit of the image processing apparatus to which the present invention is applied can be characterized by judging the show-through effect degree based on the density of the image information acquired by the image information acquiring unit, the edge degree obtained from image information and the kind of sheet printed. The layout processing unit can be characterized by executing layout processing based on the density information of the image printed on both surfaces of the sheet.

If the step of determining the image formation condition of the image processing method to which the present invention is applied is characterized by determining the image formation condition based on the influence that the image formed on one of the first surface and second surface of the sheet gives to the image formation of the other, for example, the trouble in which the image information is disturbed by the show-through effect can be reduced.

Further, the step of calculating the concentrations of the image formed on the first surface and image formed on the second surface, and the step of detecting the edge degree of the image formed on the first surface and image formed on the second surface are included. If the step of determining the above image formation condition is characterized by determining the image formation condition from the density calculated and the edge degree detected, it is preferable that the show-through effect degree can be more correctly judged.

The function for setting the layout of the program to which the present invention is applied can be set in the direction in which the overlap of the photographic image information is lost on both surfaces of the sheet, or nearly the whole is overlapped. The function for making the computer realize the function for judging the show-through effect degree of the photographic image information on both surfaces of the sheet and for setting the above layout can be characterized by setting the layout of the photographic image information on both surfaces of the sheet based on the show-through effect degree judged.

As the example of practical use of the present invention, a computer device used for a store or the like providing a photograph output service, an image forming system and a server or the like providing information via the Internet or the like are considered.

The entire disclosure of Japanese Patent Application No. 2003-328544 filed on Sep. 19, 2003 including specification, claims, drawing and abstract is incorporated herein by reference in its entirely.

1. An image outputting system comprising:
an image information acquiring unit to acquire image information to be printed on a sheet;
a rear surface information acquiring unit to acquire rear surface information of the sheet on which the image information acquired by the image information acquiring unit is printed;
a layout determining unit to determine a layout of the image information acquired by the image information acquiring unit to the sheet based on the rear surface information of the sheet acquired by the rear surface information acquiring unit; and
a printing unit to print the image information on the layout determined by the layout determining unit.

2. The image outputting system according to claim 1, wherein
the rear surface information acquiring unit judges a show-through effect degree by calculation of an average density of an image formed on the rear surface of the sheet and/or detection of edge degree.

3. The image outputting system according to claim 1, wherein
the layout determining unit determines the layout in which the image information is not overlapped with the rear surface image of the sheet.

4. The image outputting system according to claim 3, wherein
the layout determining unit determines the layout in which the image formed on the sheet is not overlapped with the rear surface image when a density of the image formed on the sheet is low.

5. The image outputting system according to claim 1, wherein the layout determining unit determines a printing position in which the image information is overlapped with the rear surface image of the sheet.

6. The image outputting system according to claim 5, wherein
the layout determining unit determines the layout in which the region where the image information is overlapped with the rear surface image is the largest.

7. The image outputting system according to claim 5, wherein
the layout determining unit determines the layout in which the image information is overlapped with the rear surface image while length corresponds to length, and side corresponds to side when the image information is mixed lengthways and sideways.

8. The image outputting system according to claim 1, further comprising:
a text information input unit to input text information, wherein
the layout determining unit determines the layout based on the text information.

9. An image outputting system comprising:
a photographic image acquiring unit to acquire a plurality of photographic images photographed;
a layout setting unit to rearrange the plurality of photographic images acquired by the photographic image acquiring unit in consideration of an overlap condition on both surfaces of a sheet, and setting a layout of both surfaces of the sheet; and
a printing unit to print the plurality of photographic images on both surfaces of the sheet according to the layout set by the layout setting unit.

10. The image outputting system of claim 9, further comprising:
a scene information inputting unit to input scene information at a time of photographing in the photographic images acquired by the photographic image acquiring unit, wherein
the layout setting unit sets the layout of both surfaces of the sheet based on the scene information inputted by the scene information inputting unit.

11. An image processing apparatus which executes processing to print an image on both surfaces of a sheet comprising:
an image information acquiring unit to acquire image information to be printed;
a recognizing unit to recognize rear surface information of an image formed on the rear surface of the sheet from the image information acquired by the image information acquiring unit; and
a surface image formation condition determining unit to determine an image formation condition of the image formed on the surface of the sheet based on the rear surface information recognized by the recognizing unit.

12. The image processing apparatus according to claim 11, wherein
the surface image formation condition determining unit determines a layout of the image formed on the surface of the sheet.

13. The image processing apparatus according to claim 12, wherein
the surface image formation condition determining unit determines the layout of the image formed on the surface of the sheet based on a position of the image formed on the rear surface of the sheet.

14. The image processing apparatus according to claim 11, wherein
the image information acquired by the image information acquiring unit contains photographic image information, and
the surface image formation condition determining unit determines a layout of photographic image information.

15. An image processing apparatus which executes processing to print an image on both surfaces of a sheet comprising:
an image information acquiring unit to acquire image information to be printed;
a show-through effect degree judging unit to judge a show-through effect degree of an image formed on both surfaces of the same sheet from image information acquired by the image information acquiring unit;
a layout processing unit to subject at least one of both surfaces on the sheet from judgment due to the show-through effect degree judging unit to layout processing; and
an outputting unit to output the image information subjected to layout processing by the layout processing unit.

16. The image processing apparatus according to claim 15, wherein
the show-through effect degree judging unit judges the show-through effect degree based on a density of the image information acquired by the image information acquiring unit, an edge degree obtained from the image information and a kind of sheet printed.

17. The image processing apparatus according to claim 15, wherein
the layout processing unit executes layout processing based on density information of the image printed on both surfaces of the sheet.

18. An image processing method for printing an image on first surface and second surface of a sheet comprising the steps of:
acquiring image information to be printed;
developing the image formed on the first surface and second surface of the sheet for the image information acquired on a memory;
judging overlap situation of the first surface and second surface in the sheet based on the image developed on the memory; and
determining image formation condition of the first surface and/or second surface from overlap situation judged.

19. The image processing method according to claim 18, wherein
the step of determining the image formation condition determines the image formation condition based on influence that the image formed on one of the first surface and second surface of the sheet applies to the other image formation.

20. The image processing method according to claim 18, further comprising the steps of:
calculating a density of the image formed on the first surface and image formed on the second surface; and
detecting an edge degree of the image formed on the first surface and image formed on the second surface,
wherein the step of determining the image formation condition determines the image formation condition from the density calculated and the edge degree detected.

21. The image processing method according to claim 20, further comprising the step of:
inputting text information, wherein
wherein the step of determining the image formation condition determines the image formation condition based on the text information.

22. A program which realizes a function for inputting photographic image information to be printed on both surfaces of a sheet to a computer and developing information on a memory, a function for judging overlap situation of the photographic image information on both surfaces of the sheet from the photographic image information developed, and a function for setting a layout of the photographic image information on both surfaces of the sheet from the overlap situation judged.

23. The program according to claim 22, wherein
the function for setting the layout loses an overlap of the photographic image information on both surfaces of the sheet, or is composed to be capable of being set in a direction for overlapping nearly a whole.

24. The program according to claim 22, wherein
the computer is further made to realize a function for judging a show-through effect degree in the photographic image information on both surfaces of the sheet, and
the function for setting the layout sets the layout of the photographic image information on both surfaces of the sheet based on the show-through effect degree judged.
